(19) United States
(12) Patent Application Publication
(10) Pub. No.: US 2026/0103841 A1
(43) Pub. Date: Apr. 16, 2026

(54) PAPERBOARD COMPRISING RECYCLED FIBRES

(71) Applicant: BILLERUD AKTIEBOLAG (PUBL), Solna (SE)

(72) Inventors: Mats Haggquist, Gavle (SE); Fredrik Nordstrom, Karlstad (SE)

(21) Appl. No.: 19/122,447

(22) PCT Filed: Oct. 19, 2023
(86) PCT No.: PCT/EP2023/079159

§ 371 Date: Apr. 18, 2025

(30) Foreign Application Priority Data
Oct. 19, 2022 (EP) 22202547.0

(51) Int. Cl. D21H 11/14; B32B 29/00; D21H 11/04; D21H 27/30

(52) U.S. Cl. CPC D21H 11/14; B32B 29/005; D21H 11/04; D21H 27/30; B32B 2250/03; B32B 2250/26; B32B 2305/70

(57) ABSTRACT

The present disclosure provides a method of producing a paperboard comprising a top layer, a back layer and a middle layer, said method comprising the steps of: —providing a first fraction of a pulp of recycled bleached fibers, which first fraction has a Schopper-Riegler value measured according to ISO 5267-1:1999 of below 24; —forming a middle layer furnish comprising a chemithermomechanical pulp (CTMP) and the first fraction; and —forming said middle layer from said middle layer furnish.

### TECHNICAL FIELD

The present disclosure relates to the field of paperboard and production thereof.

### BACKGROUND

Traditionally, only virgin pulps have been used to form high-quality paperboard. In case of a multi-layered paperboard of at least three layers, which is a common type of paperboard in Europe, chemical pulps, predominantly kraft pulps, are typically used for the outer layers, while a mechanical pulp in combination with a chemical pulp is often used for the middle layer(s). Further, broke pulp, which is inevitably generated in paperboard production, is typically included in the formation of paperboard.

### SUMMARY

The objective of the present disclosure is to include recycled fibres in paperboard while maintaining or even improving properties characteristic of high-quality paperboard.

Accordingly, the present disclosure provides a method of producing a paperboard comprising a top layer, a back layer and a middle layer, said method comprising the steps of:
providing a first fraction of a pulp of recycled bleached fibers, which first fraction has a Schopper-Riegler value measured according to ISO 5267-1:1999 of below 24;
forming a middle layer furnish comprising a chemithermomechanical pulp (CTMP) and the first fraction; and
forming said middle layer from said middle layer furnish.

The present disclosure further provides a paperboard comprising a top layer, a back layer and a middle layer, wherein the middle layer comprises:
a first fraction of a pulp of recycled bleached fibers, which first fraction has a Schopper-Riegler value measured according to ISO 5267-1:1999 of below 24; and
chemithermomechanical pulp (CTMP).

As shown in the Examples section below, the present disclosure enables the formation of a paperboard of equal bending resistance as that of a prior art paperboard (formed from virgin pulp only) at a lower total fibre consumption. In other words, the present disclosure not only enables the introduction of a significant portion of recycled fibres in high-quality paperboard without sacrificing the bending resistance of the board, but it also enables a reduction of the amount of fibres needed to reach the desired bending resistance.

### DETAILED DESCRIPTION

As first aspect of the present disclosure, there is provided a method of producing a paperboard comprising a top layer, a back layer and a middle layer. As understood by the skilled person, the middle layer is arranged between the top layer and the back layer. The top layer is preferably a white top layer, i.e. a layer formed from bleached fibres. The top layer is typically intended for printing. Hence, the top layer may be provided with a pigment-based coating, which may consist of several sublayers applied in consecutive coating steps.

The method comprises the steps of:
providing a first fraction of a pulp of recycled bleached fibers, which first fraction has a Schopper-Riegler value measured according to ISO 5267-1:1999 of below 24, preferably below 22, more preferably below 20;
forming a middle layer furnish comprising a chemithermomechanical pulp (CTMP) and the first fraction; and
forming said middle layer from said middle layer furnish.

In one embodiment, the first fraction constitutes at least 15% by dry weight of the middle layer furnish, such as at least 25% by dry weight of the middle layer furnish. An upper limit may be 60% by dry weight of the middle layer furnish.

In one embodiment, CTMP constitutes at least 20% by dry weight of the middle layer furnish, such as at least 30% by dry weight of the middle layer furnish. An upper limit may be 50% by dry weight of the middle layer furnish.

In one embodiment, said middle layer furnish further comprises broke pulp. The broke pulp may constitute at least 12% by dry weight of the middle layer furnish, such as at least 17% by dry weight of the middle layer furnish. An upper limit may be 35% by dry weight of the middle layer furnish.

In an embodiment, the density according to ISO 534:2011 of first fraction is below 610 kg/m³ after sheet forming according to ISO 5269-2:2004. As an example, this density may be 550-610 kg/m³.

In one embodiment, the tensile stiffness index according to ISO 1924-3:2011 of the first fraction is at least 4.6 MNm/kg after sheet forming according to ISO 5369-2:2004. As an example, this tensile stiffness index may be 4.6-5.3 MNm/kg.

The middle layer furnish may further comprise one or more strength agents, such as starch (preferably cationic starch), carboxymethyl cellulose (CMC) and/or microfibrillated cellulose (MFC).

In one embodiment, the paperboard is a liquid packaging board (LPB). In such an embodiment, each of the (fibre-based) layers of the paperboard comprise hydrophobic size. The hydrophobic size is preferably selected from the group consisting of ASA, AKD, rosin size and combinations thereof.

The amount of hydrophobic size in the middle layer furnish may for example be at least 2.5 kg/tonne dry fibre, such as at least 3.0 kg/tonne dry fibre. The amount of hydrophobic size in the outer layers is preferably lower than the amount of hydrophobic size in the middle layer.

In a preferred embodiment, the hydrophobic size in each of the furnishes of the method of the first aspect is a combination of AKD and rosin size. When such a combination is used, the headbox pH of the furnishes is preferably in the range of 6.6-7.2, such as 6.9-7.1.

In one embodiment, the first fraction is obtained by hydrocyclone fractionation of the pulp of recycled bleached fibers (see e.g. Example 2 below). In such an embodiment, the Schopper-Riegler value measured according to ISO 5267-1:1999 is preferably below 20, more preferably below 19.

In another embodiment, the first fraction is obtained by screening of the pulp of recycled bleached fibers (see e.g. Example 1 below).

In an embodiment of the method in which the top layer is a white top layer, said method further comprises:
providing a second fraction of the pulp of recycled bleached fibers;
forming a top layer furnish comprising the second fraction; and
forming said top layer from said top layer furnish.

In this embodiment, second fraction has a Schopper-Riegler value (measured according to ISO 5267-1:1999) above that of the first fraction, e.g. above 24, such as above 31. It follows from the above that the second fraction is preferably obtained by hydrocyclone fractionation of the pulp of recycled bleached fibers. However, it may also be obtained by screening of the pulp of recycled bleached fibers.

In an embodiment, the density according to ISO 534:2011 of second fraction is above 600 kg/m³ after sheet forming according to ISO 5269-2:2004. As an example, this density may be at least 610 kg/m³, such as 610-650 kg/m³.

In one embodiment, the tensile stiffness index according to ISO 1924-3:2011 of the second fraction is at least 4.8 MNm/kg after sheet forming according to ISO 5269-2:2004. As an example, this tensile stiffness index may be 5.0-5.4 MNm/kg.

The first fraction to second fraction mass flow ratio may for example be in the range of 1:1 to 1:2, such as in the range of 1:1.1 to 1:2, such as in the range of 1:1.2 to 1:1.9.

In one embodiment, the second fraction constitutes at least 25% by dry weight of the top layer furnish, such as at least 35% by dry weight of the top layer furnish, such as at least 45% by dry weight of the top layer furnish.

In addition to the second fraction, the white top layer furnish preferably comprises a bleached chemical pulp, such as a bleached kraft pulp. As understood by the skilled person, this chemical pulp is a virgin pulp.

Also, the method of the first aspect may further comprise the steps of:
forming a back layer furnish comprising at least 60% by dry weight of kraft pulp, such as at least 70% by dry weight of kraft pulp; and
forming said back layer from said back layer furnish.

In one embodiment, the back layer furnish further comprises broke pulp.

The grammage, excluding any coating layers, of the paperboard formed by the method of the first aspect may for example be 120-400 g/m² when measured according to ISO 536:2019. If pigment-coating layers are included, the grammage may be 140-420 g/m², such as 150-350 g/m².

The grammage of the middle layer is preferably higher than the grammage of the top layer. In one embodiment, the grammage of the middle layer is higher than the grammage of each of the top layer and the back layer. As an example, each of the top layer and the back layer may have a grammage below 80 g/m², while the grammage of the middle layer is above 100 g/m², such as at least 115 g/m², such as 115-150 g/m².

In a particular embodiment, the grammage of the top layer is below 80 g/m², the grammage of the back layer is below 65 g/m² and the grammage of the middle layer is higher than the grammage of each of the top layer and the back layer, e.g. above 100 g/m².

In one embodiment, recycled fibres constitute 18%-32% by dry weight of the total amount of fibres used to form the paperboard according to the first aspect.

In one embodiment, the top layer furnish and the back layer furnish comprise no recycled pulp or broke pulp.

In one embodiment, CTMP constitutes 16%-22% by dry weight of the total amount of fibres used to form the paperboard according to the first aspect.

In one embodiment, broke pulp constitutes 10%-20%, such as 10%-16%, by dry weight of the total amount of fibres used to form the paperboard according to the first aspect.

As understood by the skilled person, the method of the first aspect typically comprises a step of couching to join the paperboard layers to each other.

As a second aspect of the present disclosure paperboard, such as a paperboard obtained according to the first aspect. The paperboard of the first aspect comprises a top layer (preferably a white top layer), a back layer and a middle layer, wherein the middle layer is formed from a furnish comprising a first fraction of a pulp of recycled bleached fibers and chemithermomechanical pulp (CTMP). The first fraction has a Schopper-Riegler value measured according to ISO 5267-1:1999 of below 24.

The embodiments of the first aspect apply to the second aspect mutatis mutandis.

### EXAMPLES

A white recycled paper “White High Grade” was purchased from the company Prezero. The recycled paper was slushed in a pulper for 15 minutes to produce a crude recycled pulp that was stored in a tank. The crude recycled pulp was subjected to coarse screening using a screen having 2 mm diameter holes to obtain a recycled pulp and a coarse reject. The main reason for the coarse screening was to remove trash and impurities.

The recycled pulp was fractionated by screening to obtain a long fibre fraction and a short fibre fraction (see Example 1 below) or by hydrocyclones to obtain a coarse fibre fraction and a fine fibre fraction (see Example 2 below). Unfractionated recycled pulp was however used in Example 3.

In many board applications, the bending resistance may be considered the most important parameter. Hence, the effect on bending resistance of including the recycled pulp in a board structure was calculated using the layer grammage and the density and tensile stiffness index (TSI) values in accordance with the method devised by Carlsson and Fellers in a journal article titled FLEXURAL STIFFNESS OF MULTI-PLY PAPERBOARD (Fibre Science and Technology 13 (1980) 213-223). This required the conversion of bending stiffness (S^{b}) values to bending resistance values (having the unit mN), which was done according to the following formula: Bending resistance (mN)=S^{b}/0.084 (see Pappersteknik page 318, Gavelin, FoU medd. 13/1979).

In more detail, it was calculated which board grammage that was needed after replacing a portion of the pulp in a reference board with recycled fibres to obtain the same bending resistance as that of the reference board. The pulp replacements that were made are shown below.

In these calculations, a 250 g/m² prior art liquid packaging board structure having the composition of table 1 was used as a reference. The pulps of this prior art board structure were the following:
Bleached hardwood kraft pulp (BHKP) having a density of 750 kg/m³ and a TSI of 7.0 MNm/kg;
More refined bleached softwood kraft pulp (BSKP high) having a density of 692 kg/m³ and a TSI of 5.1 MNm/kg;
Less refined bleached softwood kraft pulp (BSKP low) having a density of 654 kg/m³ and a TSI of 4.5 MNm/kg;
Unbleached kraft pulp (UKP) having a density of 681 kg/m³ and a TSI of 5.5 MNm/kg;
CTMP having a density of 456 kg/m³ and a TSI of 3.1 MNm/kg; and
Broke pulp (Broke) having a density of 647 kg/m³ and a TSI of 5.0 MNm/kg (the density and TSI values were determined according to ISO 534:2011 and ISO 1924-3:2011, respectively, after sheet forming according to ISO 5269-2:2004).

TABLE 1
Reference (1^{st}) board structure

| | Pulp | Gsm | Density | TSI |
|---|---|---|---|---|
| Layer | composition | (g/m²) | (kg/m³) | (MNm/kg) |
| Top | BHKP: 30% | 70 | 709^{#} | 5.7^{¤} |
| | BSKP high: 70% | | | |
| Middle | CTMP: 35% | 130 | 583 | 4.1 |
| | Broke: 25% | | | |
| | BSKP low: 40% | | | |
| Back | UKP: 100% | 50 | 681 | 5.5 |

^{#}30%*750 + 70%*692 = 709 (corresponding calculations are used for the other layers of this Examples section)
^{¤}35%*3.1 + 25%*5.0 + 40%*4.5 = 4.1 (corresponding calculations are used for the other layers this Examples section)

In the reference board structure and in the modified board structures presented belove, the proportion of broke pulp is about 13% to reflect a full-scale process in which a broke pulp stream corresponding to 13% of the total amount of fibres is generated and subsequently accommodated by the full-scale process.

### Example 1

The recycled pulp was fractionated by screening using a screen having 1 mm diameter holes to obtain a long fibre fraction and a short fibre fraction in a 39:61 mass flow ratio. Properties of the fractions are presented in table 2 below.

TABLE 2
“Gsm” means grammage. “Gurley” means Gurley porosity.
“TS” means tensile stiffness. “TSI” means tensile
stiffness index. “Brightn.” means Brightness D65.

| | Property | | | | | | | |
|---|---|---|---|---|---|---|---|---|
| | SR | Gsm* | Caliper* | Density* | Brightn.* | Gurley* | TS* | TSI* |
| | Unit | | | | | | | |
| | | g/m² | μm | kg/m³ | % | s | kN/m | MNm/kg |
| Short | 26- | 110 | 180 | 612 | 101 | 10.6 | 550 | 5.0 |
| fraction | 30 | | | | | | | |
| Long | 19- | 107 | 180 | 597 | 100 | 7.8 | 525 | 4.9 |
| fraction | 23 | | | | | | | |

*Property measured after sheet forming according to ISO 5269-2: 2004.

Notably, the long fraction has higher TSI and lower density than the less refined bleached softwood kraft pulp (BSKP low). Further, the TSI of the short fraction is almost as high as that of the more refined bleached softwood kraft pulp (BSKP high), which is striking given that the short fraction has much lower density than the BSKP high.

### Example 1.1

To obtain a recycled fibre content of about 25%, the kraft pulp and some of the broke pulp of the middle layer of the reference board was replaced with the long fraction. To still accommodate all the broke pulp, some of it was added to the back layer. The resulting board composition is shown in table 3 below.

TABLE 3
Inventive board structure 1.1.

| | | Density | TSI |
|---|---|---|---|
| Layer | Pulp composition | (kg/m³) | (MNm/kg) |
| Top | BHKP: 30% | 709 | 5.7 |
| | BSKP high: 70% | | |
| Middle | CTMP: 35% | 556 | 4.3 |
| | Broke: 17% | | |
| | BSKP low: 0% | | |
| | Long fraction: 48% | | |
| Back | UKP: 79% | 674 | 5.4 |
| | Broke: 21% | | |

The grammage needed for board structure 1.1 to reach the same bending resistance as the reference board is presented under Results below.

### Example 1.2

To obtain a recycled fibre content of about 25%, about half of the kraft pulp of the middle layer and most of the softwood kraft pulp of the top layer of the reference board were replaced with the long fraction and the short fraction, respectively. The resulting board composition is shown in table 4 below.

TABLE 4
Inventive board structure 1.2.

| | | Density | TSI |
|---|---|---|---|
| Layer | Pulp composition | (kg/m³) | (MNm/kg) |
| Top | BHKP: 30% | 666 | 5.6 |
| | BSKP high: 16% | | |
| | Short fraction: 54% | | |
| Middle | CTMP: 35% | 572 | 4.2 |
| | Broke: 25% | | |
| | BSKP low: 21% | | |
| | Long fraction: 19% | | |
| Back | UKP: 100% | 681 | 5.5 |

The mass ratio between the long fraction in the middle layer and the short fraction in the back layer is the same as the above-mentioned mass flow ratio (i.e. 39:61). Accordingly, the composition of board structure 1.2 is such that the board accommodates all fibres of both fractions. The grammage needed for board structure 1.2 to reach the same bending resistance as the reference board is presented under Results below.

### Example 2

The recycled pulp was fractionated by hydrocyclones to obtain a coarse fibre fraction and a fine fibre fraction in a 38:62 mass flow ratio. Properties of the fractions are presented in table 5 below.

TABLE 5
“Gsm” means grammage. “Gurley” means Gurley porosity.
“TS” means tensile stiffness. “TSI” means tensile
stiffness index. “Brightn.” means Brightness D65.

| | Property | | | | | | | |
|---|---|---|---|---|---|---|---|---|
| | SR | Gsm* | Caliper* | Density* | Brightn.* | Gurley* | TS* | TSI* |
| | Unit | | | | | | | |
| | | g/m² | μm | kg/m³ | % | s | kN/m | MNm/kg |
| Fine | 29- | 109 | 176 | 620 | 99 | 15.8 | 561 | 5.2 |
| fraction | 37 | | | | | | | |
| Coarse | 17 | 89 | 155 | 574 | 101 | 2.9 | 453 | 5.1 |
| fraction | | | | | | | | |

*Property measured after sheet forming according to ISO 5269-2: 2004.

Notably, the coarse fraction has much higher TSI and much lower density than the less refined bleached softwood kraft pulp (BSKP low). Further, the TSI of the fine fraction is slightly higher than that of the more refined bleached softwood kraft pulp (BSKP high), which is striking given that the fine fraction has much lower density than the BSKP high.

### Example 2.1

To obtain a recycled fibre content of about 25%, the kraft pulp and some of the broke pulp of the middle layer of the reference board was replaced with the coarse fraction. To still accommodate all the broke pulp, some of it was added to the back layer. The resulting board composition is shown in table 6 below.

TABLE 6
Inventive board structure 2.1.

| | | Density | TSI |
|---|---|---|---|
| Layer | Pulp composition | (kg/m³) | (MNm/kg) |
| Top | BHKP: 30% | 709 | 5.7 |
| | BSKP high: 70% | | |
| Middle | CTMP: 35% | 545 | 4.4 |
| | Broke: 17% | | |
| | BSKP low: 0% | | |
| | Coarse fraction: 48% | | |
| Back | UKP: 79% | 674 | 5.4 |
| | Broke: 21% | | |

The grammage needed for board structure 2.1 to reach the same bending resistance as the reference board is presented under Results below.

### Example 2.2

To obtain a recycled fibre content of 25%, about half of the kraft pulp of the middle layer and most of the softwood kraft pulp of the top layer of the reference board were replaced with the coarse fraction and the fine fraction, respectively. The resulting board composition is shown in table 7 below.

TABLE 7
Inventive board structure 2.2.

| | | Density | TSI |
|---|---|---|---|
| Layer | Pulp composition | (kg/m³) | (MNm/kg) |
| Top | BHKP: 30% | 670 | 5.7 |
| | BSKP high: 15% | | |
| | Fine fraction: 55% | | |
| Middle | CTMP: 35% | 568 | 4.3 |
| | Broke: 25% | | |
| | BSKP low: 22% | | |
| | Coarse fraction: 18% | | |
| Back | UKP: 100% | 681 | 5.5 |

The mass ratio between the coarse fraction in the middle layer and the fine fraction in the back layer is the same as the above-mentioned mass flow ratio (i.e. 38:62). Accordingly, the composition of board structure 2.2 is such that the board accommodates all fibres of both fractions. The grammage needed for board structure 2.2 to reach the same bending resistance as the reference board is presented under Results below.

### Example 3 (2^{nd} Reference)

To obtain a recycled fibre content of 25%, all of the softwood kraft pulp and most of the hardwood kraft pulp of the top layer were replaced with the (unfractionated) recycled pulp. The resulting board composition is shown in table 8 below.

TABLE 8
Second reference board structure.

| | | Gsm | Density | TSI |
|---|---|---|---|---|
| Layer | Pulp composition | (g/m²) | (kg/m³) | (MNm/kg) |
| Top | BHKP: 11% | 70 | 624 | 4.8 |
| | BSKP high: 0% | | | |
| | Recycled pulp: 89% | | | |
| Middle | CTMP: 35% | 130 | 583 | 4.1 |
| | Broke: 25% | | | |
| | BSKP low: 40% | | | |
| Back | UKP: 100% | 50 | 681 | 5.5 |

The grammage needed for the second reference board structure to reach the same bending resistance as the reference board is presented under Results below.

### Results

TABLE 9
Board structures having about the same bending resistance. “TL”, “ML”
and “BL” means top layer, middle layer and back layer, respectively.
“Recycl.” means recycled fibres. Numbers in bold shows change compared to reference.

| Board | Layer | Total | Bending | Broke | Recycl. | CTMP |
|---|---|---|---|---|---|---|
| structure | grammage | grammage | resistance | (%) | (%) | (%) |
| 1^{st} ref. | TL: 70 g/m² | 250 g/m² | 221.1 mN | 13.0 | 0 | 18.2 |
| | ML: 130 g/m² | | | | | |
| | BL: 50 g/m² | | | | | |
| 1.1 | TL: 70 g/m² | 244 g/m² | 219.9 mN | 12.9 | 24.4 | 17.8 |
| | ML: 124 g/m² | (−6 g/m²) | | | | |
| | BL: 50 g/m² | | | | | |
| 1.2 | TL: 70 g/m² | 246 g/m² | 219.9 mN | 12.8 | 25.1 | 17.9 |
| | ML: 126 g/m² | (−4 g/m²) | | | | |
| | BL: 50 g/m² | | | | | |
| 2.1 | TL: 70 g/m² | 242 g/m² | 221.0 mN | 12.9 | 24.2 | 17.6 |
| | ML: 122 g/m² | (−8 g/m²) | | | | |
| | BL: 50 g/m² | | | | | |
| 2.2 | TL: 70 g/m² | 245 g/m² | 221.4 mN | 12.8 | 24.9 | 17.9 |
| | ML: 125 g/m² | (−5 g/m²) | | | | |
| | BL: 50 g/m² | | | | | |
| 2^{nd} ref. | TL: 70 g/m² | 253 g/m² | 222.0 mN | 13.1 | 24.6 | 18.4 |
| | ML: 133 g/m² | (+3 g/m²) | | | | |
| | BL: 50 g/m² | | | | | |

As shown in Table 9, the inventive concept not only enables a replacement of a significant portion of virgin fibres by recycled fibres, but it also allows for a reduction of the total fibre consumption without a loss of bending resistance. Particularly beneficial results are obtained with hydrocyclone fractions (2.1, 2.2).

1. A method of producing a paperboard comprising a top layer, a back layer and a middle layer, said method comprising the steps of:
providing a first fraction of a pulp of recycled bleached fibers, which first fraction has a Schopper-Riegler value measured according to ISO 5267-1:1999 of below 24;
forming a middle layer furnish comprising a chemithermomechanical pulp (CTMP) and the first fraction; and
forming said middle layer from said middle layer furnish,
wherein the first fraction constitutes at least 15% by dry weight of the middle layer furnish and the CTMP constitutes at least 20% by dry weight of the middle layer furnish.

2. The method of claim 1, wherein the first fraction constitutes at least 25% by dry weight of the middle layer furnish.

3. The method of claim 1, wherein the CTMP constitutes at least 30% by dry weight of the middle layer furnish.

4. The method of claim 1, wherein said middle layer furnish further comprises broke pulp.

5. The method of claim 4, wherein broke constitutes at least 12% by dry weight of the middle layer furnish, by dry weight of the middle layer furnish.

6. The method of claim 1, wherein the first fraction has a Schopper-Riegler value measured according to ISO 5267-1:1999 of below 22.

7. The method of claim 1, wherein the first fraction is obtained by hydrocyclone fractionation of the pulp of recycled bleached fibers.

8. The method of claim 1, wherein the top layer is a white top layer, said method further comprising:
providing a second fraction of the pulp of recycled bleached fibers, which second fraction has a Schopper-Riegler value measured according to ISO 5267-1:1999 of above 24;
forming a top layer furnish comprising the second fraction; and
forming said top layer from said top layer furnish.

9. The method of claim 8, wherein the second fraction is obtained by hydrocyclone fractionation of the pulp of recycled bleached fibers.

10. The method of claim 8, wherein the first fraction to second fraction mass flow ratio is in the range of 1:1 to 1:2.

11. The method of claim 8, wherein the second fraction constitutes at least 25% by dry weight of the top layer furnish.

12. The method of claim 8, wherein the top layer furnish further comprises a bleached chemical pulp.

13. The method of claim 8, wherein the second fraction has a Schopper-Riegler value measured according to ISO 5267-1:1999 of above 31.

14. The method of claim 1, wherein the grammage of the middle layer is higher than the grammage of the top layer.

15. The method of claim 14, wherein the grammage of the middle layer is higher than the grammage of each of the top layer and the back layer.

16. A paperboard comprising a top layer, a back layer and a middle layer, wherein the middle layer comprises:
a first fraction of a pulp of recycled bleached fibers, which first fraction has a Schopper-Riegler value measured according to ISO 5267-1:1999 of below 24; and
chemithermomechanical pulp (CTMP),
wherein the first fraction constitutes at least 15% by dry weight of the middle layer and the CTMP constitutes at least 20% by dry weight of the middle layer.

17. The method of claim 12, wherein the bleached chemical pulp is a bleached kraft pulp.
